(19) United States
(12) Patent Application Publication
(10) Pub. No.: US 2026/0249638 A1
(43) Pub. Date: Aug. 27, 2026

(54) OPTICALLY VARIABLE SECURITY ELEMENT, VALUE DOCUMENT AND PRODUCTION METHOD

(71) Applicant: Giesecke+Devrient Currency Technology GmbH, Munchen (DE)

(72) Inventor: Simon PINZEK, Gmund am Tegernsee (DE)

(21) Appl. No.: 19/544,521

(22) Filed: Feb. 19, 2026

(30) Foreign Application Priority Data
Feb. 26, 2025 (DE) 102025107278.7

(51) Int. Cl. B42D 25/309; B42D 25/40

(52) U.S. Cl. CPC B42D 25/309; B42D 25/40

(57) ABSTRACT

An optically variable security element for securing security papers, value documents, or value articles is provided, which has: a substrate body defining a base plane, and a micromirror arrangement which is embodied or arranged on the substrate body and is embodied as a two-dimensional array of micromirrors which form pixels of a representation perceptible when the substrate body is viewed in plan view. The micromirror arrangement includes first micromirrors and second micromirrors, with the first micromirrors having planar mirror faces inclined relative to the base plane and at least the second micromirrors each including a biaxially curved mirror face.

### BACKGROUND

The invention relates to an optically variable security element for securing security papers, value documents, value articles or the like, which has a substrate body defining a base plane, and a micromirror arrangement which is embodied or arranged on the substrate body and is embodied as a two-dimensional array of micromirrors which form pixels of a representation perceptible when the substrate body is viewed in plan view. The micromirror arrangement comprises first micromirrors and second micromirrors, with the first micromirrors having planar mirror faces inclined relative to the base plane and at least the second micromirrors each comprising a plurality of partial mirror faces.

For the securing of value documents, such as a banknote, a check, a credit card or other payment card, an identity card or the like, foil-based security elements have been used for a long time. Since the end of the 80s, embossed holograms have been used for such foil-based security elements, and are now very widespread and can no longer offer a high level of anticounterfeiting security; they are therefore increasingly being replaced by microoptical systems.

Microoptical systems, such as micromirror arrangements, allow verification of the authenticity of the value document and at the same time increase the anticounterfeiting security, as they cannot be reproduced even with the most modern of copiers. The micromirror arrangements can be used, for example, to implement running effects that exhibit a high degree of optical variability when the security element is tilted. The micromirror arrangement here may have micromirrors of a certain surface area, e.g., squares with the dimensions 20 µm x 20 µm, or else rectangles of which one edge is very much larger than the other. Different orientations of partial faces within the micromirrors can be used to generate various optically variable effects, such as running, arching, or 3D parallax effects. One particular implementation of these effects generates flip images from two or more such effects. The individual effects here are visible in different views each at different viewing angles, but in terms of area are located at the same place. Since flip images cannot be generated by simple printing, they offer a high level of anticounterfeiting security.

The flip images described can be generated by subdividing the area that is to contain the different effects/flip motifs into groups of pixels interspersed in one another, which are interspersed, for example, with a chessboard interspersion and are visible in different views from different viewing angles, with the first effect, thus, e.g., an arching effect, occupying the "white" fields and the second effect, thus, e.g., a running effect or a different arching effect, occupying the "black" fields. Ideally, the two flip motifs differ significantly in their shape, so it is easy for the human eye to distinguish between the two motifs and thus perceive the flip when the viewing angle switches, i.e., when the view switches. The pixel groups interspersed in one another ensure that a security element with a flip effect of the motif can be subdivided into four areal regions: A first areal region displays the motifs of both flip views (depending of course on the viewing angle); in a second areal region, the motif of the first flip view is present, but not that of the second view; in a third areal region, the motif of the second flip view is present, but not that of the first view; and in a fourth areal region, none of the motifs of the two flip views is present. Whenever an effect/motif of one flip view is not present or both effects/motifs are not present in an areal region, this areal region must accordingly be occupied with a background effect. This background effect can be called a flip background, and has a similar viewing angle range to the flip motifs, in order to promote a clear separation of the two effects/motifs. In case of unclear separation, so-called ghost images would appear, meaning that, for example, a shadow of the first motif is seen, whereas actually only the second motif ought to be visible. A similar viewing angle range deviates at one or both limits by a maximum of 20°, preferably by a maximum of 10°, and more preferably by a maximum of 5°.

Of course, the sharpness of separation of the flip views may be limited such that the viewing angle ranges can overlap, so that there is a transition region in which temporarily both flip views are visible in superimposition when tilted.

The described background effects for flip motifs are typically generated via so-called noisy mirrors as micromirror arrangements. Noisy mirrors have planar mirror surfaces whose orientation in the specified viewing angle range is random and interspersed. All pixels of an interspersed areal region of the micromirror arrangement (in the example of the chessboard interspersion, for example, all white fields) which are provided with the background effect have the same or a similar viewing angle range as the actual flip effect or the actual flip motif in this region. As a result, the background has a uniform brightness at the macroscopic level, but the individual pixels of the background appear with different brightnesses, resulting in a fuzzy appearance. There are micromirror arrangements known, moreover, which in a first direction have partial faces with a constant inclination and in a second direction, perpendicular thereto, have partial faces with a curved surface, i.e., with an inclination profile. A shared aspect of the known micromirror arrangements is that when they are used for a so-called flip background, this background acquires a noisy/fuzzy appearance, and the background effect thus possesses a nonuniform brightness.

### SUMMARY

It is an object of the invention to provide a security element of the generic kind that avoids the disadvantages of the prior art and that in particular generates a nonstructured region of a representation with uniform brightness and thus an attractive optical effect. A corresponding value document and a method for producing the security element are also to be provided.

An optically variable security element is provided for safeguarding of security papers, documents of value and other articles of value. The security element has a substrate body that defines a base plane through its surface. Substrate bodies used may be polymer substrates, for example PET substrates, paper substrates, or combined paper and polymer substrates.

The substrate body bears an applied micromirror arrangement. The micromirror arrangement can either be embossed into a dielectric layer as a microfacet arrangement and then metallized with a reflective layer, or it is formed entirely from a metal layer without any need for a dielectric layer. Metals particularly suitable for the reflective layer or the metal layer, respectively, are Al, Ag, Au, Ni, Fe, Cu, W or Cr, and alloys of these metals. A multilayer coating, such as a color shift coating (e.g., absorber, dielectric, reflector), or a multilayer system of dielectrics with different refractive indices, in which high and low refractive indices alternate (e.g., ZnS-SiO₂-ZnS), can also be used as a reflective layer.

The micromirror arrangement comprises a two-dimensional array of first and second micromirrors which form pixels of a representation perceptible when the substrate body is viewed in plan view. The two-dimensional array of micromirrors preferably displays a first view of the representation at a first viewing angle, and a second view of the representation at a second viewing angle.

The first micromirrors have at least one mirror face inclined relative to the base plane, so that they represent a structured region of the representation: for example, a motif. It is also possible equally for the first micromirrors to represent at least two motifs – so-called flip motifs – at different viewing angles. In that case, a first motif is visible in a first view in a first viewing angle range and switches, in a second view in a different, second, likewise defined viewing angle range, into a second motif, which is likewise visible over the entire viewing angle range. The motif switch is preferably static when switching from the first into the second viewing angle range; i.e., when switching from the first viewing angle range into the second viewing angle range, the first motif disappears completely and the second motif appears. A so-called flip image or flip motif is represented. In the first and second viewing angle ranges, the respective motifs have no movement effect. However, it is also equally possible for the motifs in the two viewing angle ranges to have mutually different optically variable effects, such as running, arching, or parallax effects. For example, it would be possible for a running effect in the first viewing angle range to flip statically, on switching into the second viewing angle range, into a different running effect or an arching effect, for example. For the purposes of this patent application, the term vision angle range is also used. Vision angle range denotes an angular range in which the security element is tilted when viewed perpendicularly and thus represents an equivalent to the viewing angle range.

The second micromirrors comprise a mirror face which is biaxially curved. More preferably, the second micromirrors comprise a plurality of partial mirror faces, which each individually are not discernible to the naked eye. The mirror face in such embodiments is formed by the partial mirror faces, between which there are jump discontinuities, so that the partial mirror faces embody a Fresnel structure. Such a structure ensures that the reflective properties of the partial mirror faces and the mirror face are substantially equal, but material is saved in an embossing process, since in order to obtain the same reflective effect, less embossing varnish is required in the production of the Fresnel structure, so that material is saved and thus the production costs are reduced. Of course, it is also equally possible for the first micromirrors too to comprise a plurality of partial mirror faces. If the second micromirrors have a plurality of partial mirror faces, the partial mirror faces are also biaxially curved. The reflecting surface of the mirror face or the reflecting surfaces of the partial mirror faces have a plurality of inclinations, i.e., an inclination profile, in each of two mutually perpendicular directions. The surface of the mirror face or the surfaces of the partial mirror faces of the second micromirrors are curved in two mutually perpendicular directions. It is also possible to refer to a two-dimensional arching of the mirror face or the partial mirror faces. The second micromirrors generate a matt or smooth effect, preferably forming pixels in a nonstructured region of a representation. One such nonstructured region would be, for example, the background of a motif representation.

For the mirror face or the partial mirror faces of the second micromirrors, an identical/comparable vision angle range as may be used, for example, with a conventional flip background is provided. The curvature in the two directions is selected in such a way that each pixel of the second micromirrors covers the same vision angle range. As a result, each of these pixels is always visible when tilting within this vision angle range and preferably possesses a constant brightness. However, it is important here that the partial mirror faces of the second micromirrors are biaxially curved. This means that the partial mirror faces of the second micromirrors must have a curvature both on tilting of the security element in a first direction - for example, in the north-south direction - and on tilting in a direction perpendicular to this - i.e., in this example, in the east-west direction. This constitutes a substantial difference to known regions of a representation that are generated with micromirrors, whose partial mirror faces have a random tilt in the north-south direction and a random tilt in the east-west direction – the partial mirror faces have no inclination profile. In the case of known micromirror arrangements, this leads to a visual effect that is indeed uniform when viewed from a distance, but on closer viewing the individual pixels light up with different brightnesses, leading to a grainy or fuzzy appearance.

The second micromirrors may be used, for example, as pixels of a flip background. It is essential here that the second micromirrors are provided with biaxially curved mirror faces or partial mirror faces, which owing to the reflective layer or the metal layer represent curved mirrors which fit the vision angle range of the motif represented by the first micromirrors that the second micromirrors together are intended to light up. If the security element is tilted and so the flip from the first motif to the second motif is completed, the second micromirrors always appear in substantially uniform brightness, regardless of the tilt angle of the security element and the resulting vision angle range. Even in areal regions where first and second micromirrors are present, the second micromirrors have a substantially uniform brightness. A substantially uniform brightness here means that the brightness of the second micromirrors may vary in its intensity, but the brightness in the range of visibility varies only slowly and the brightness distribution as viewed across all pixels is smooth, i.e., not grainy or fuzzy.

Uniform brightness of the nonstructured region of a representation, i.e., for example, of the flip background, is more preferably achieved in that a multiplicity of second micromirrors possess the same surface curvature in their mirror face or in their partial mirror faces.

For example, the security element described generates a background effect with matt appearance and uniform brightness over a defined tilt angle range. The background effect of the second micromirrors is used, for example, for flip motifs that are generated with the first micromirrors, and additionally ensures that the ghost images described earlier are outshone and thus ideally cannot be discerned by the external viewer. This too improves the visual attractiveness of the security element.

Preferably, the first view of the representation that is visible with the first viewing angle range is shown by a first pixel group and the second view of the representation that is visible with the second viewing angle range is shown by a second pixel group. In that case, more preferably, the micromirrors of the two pixel groups are interspersed with one another at least in one region of the micromirror arrangement. The respective pixel groups then light up only at a certain viewing angle, with the first pixel group lighting up in a different viewing angle range from the second pixel group. Within the respective pixel group, first micromirrors and second micromirrors may light up jointly.

The joint lighting-up of the first micromirrors together with the second micromirrors is achieved as a result of the described interspersion. Preferably, at least in one areal region of the micromirror arrangement, first micromirrors of the first pixel group and second micromirrors of the second pixel group are arranged repeatedly next to each other. More preferably, the described interspersion is in the form of a chessboard. In this case, the white faces of the chessboard reflect at the viewing angles of the first view of the representation, i.e., the first micromirrors and the associated second micromirrors with the same viewing angle range, and the black faces of the chessboard reflect at the viewing angles of the second view of the representation, i.e., the first micromirrors and the associated second micromirrors with the same viewing angle range. The first micromirrors and the second micromirrors have the same or a similar vision angle range; thus, their motifs/effects are visible in a substantially identical vision angle range. As a rule, the white and black faces of the chessboard differ primarily in their vision angle range in the north-south direction. As a consequence, adjacent micromirrors may also have different curvatures of their mirror faces or partial mirror faces, or first micromirrors without curvature of the surface of their partial faces may be arranged next to second micromirrors with curved partial mirror faces; this results exactly from the interspersed arrangement described.

Preferably, in at least one areal region of the micromirror arrangement, second micromirrors of a first type of the first pixel group and micromirrors of a second type of the second pixel group are arranged repeatedly next to one another, with the two types of second micromirrors differing in a curvature of their mirror faces or partial mirror faces. The respective pixel groups here are also arranged interspersed with one another, in the form, for example, of a chessboard pattern, thereby further improving the optical effect of the security element. In regions of the representation where there are no first micromirrors and therefore no motif is represented, only second micromirrors are present. The mirror faces or the partial mirror faces of the second micromirrors of the first type are biaxially curved, as are the mirror faces or the partial mirror faces of the second micromirrors of the second type. They have curvatures of their surface in two directions perpendicular to one another.

In preferred embodiments, the micromirror arrangement has a multilayer coating, more particularly a color shift coating. With such multilayer coatings, the micromirror arrangement is able to generate a viewing angle-dependent color effect. More preferably, the different pixel groups can also be differently coated, so that, for example, a viewing angle-dependent color change between the two views can be generated.

Preferably, at least one of the mirror faces or the partial mirror faces of the second micromirrors has a continuously curved surface shape, more preferably a parabolically curved surface shape. The curvature of the surface of the mirror faces or the partial mirror faces in the second micromirrors may thus be continuous, in the form of an arc, or in discrete steps each with a constant curvature. In the case of a continuously curved surface shape, the surface preferably has the shape of a parabola, i.e., of a 2nd-order polynomial, since in this case the second derivative is constant and so all inclinations occur uniformly often, which leads to a uniform brightness on tilting. It is possible for there to be local jump discontinuities, at the edges, for example, but also within the pixel of the micromirrors, if, for example, partial mirror faces are provided.

In embodiments, the curved surface shape of the mirror faces or the partial mirror faces of the second micromirrors may vary laterally along their surface. It is possible, for example, for the curvature to run laterally along the surface of the partial mirror faces initially in a concave way, but then to transition into a convex curvature (concave-convex) – the reverse case (convex-concave) is of course equally possible. A plurality of differently aligned parabola pieces may be arranged one after another. The partial faces in that case have a surface shape with at least one elevation and/or at least one depression. Preferably, the surface has as few local jump discontinuities as possible; more preferably, the surface shape is continuous, thus possessing no jump discontinuities.

A tangent of the curvature of the surface of the mirror faces or the partial mirror faces of the second micromirrors may be located in the range of +/- 45°, preferably of +/- 20°, more preferably of +/- 10° to the base plane defined by the substrate body. Furthermore, the first micromirrors and/or the second micromirrors preferably have dimensions of between 3 µm and 100 µm, more preferably between 5 µm and 20 µm. Further preferably, the mirror faces or the partial mirror faces of the second micromirrors extend to a maximum height of between 0.5 µm and 10 µm, more preferably between 1 µm and 5 µm, measured between the highest and lowest points of the surface.

In embodiments, the second micromirrors may be combined with further mirror faces inclined relative to the base plane, which form pixels in the nonstructured region of the representation. This combines conventional, noisy micromirrors, which generate a fuzzy image, with the second micromirrors, which generate a uniform effect in the nonstructured region of the representation. Both the noisy micromirrors and the second micromirrors have the same vision angle range at the macroscopic level and thus have a very similar visual appearance from a distance. Only when viewed from close up can a visual difference be clearly perceived between the noisy micromirrors and the second micromirrors. This allows hidden motifs to be installed in the nonstructured region: for example, in the background of the representation. For example, a sky could be represented with the second micromirrors, as a background effect, with a bird, represented as a flip motif with the first micromirrors, flying in front of this sky background. One area of the sky could be generated with noisy micromirrors, so that, for example, they represent a cloud as a fuzzy image in the otherwise uniform background. It would be conceivable to have any motifs that can be inserted into the background with the noisy micromirrors. The vision angle range here can also be chosen deliberately differently between the noisy micromirrors and the second micromirrors. Inserting an additional motif that is not perceptible from distance increases the anticounterfeiting security of the security element in a surprising way.

More preferably, the optically variable security element is a foil security element, for instance a security thread, a security tape or a security patch. It can then be easily applied as a transfer element to a value document or else embedded into the value document. The foil security element can equally be equipped with further functional layers, e.g., a machine- readable magnetic coding, a UV luminescence, a phosphorescence, an infrared coding, or similar.

Likewise provided is a value document, such as a banknote, a check, a credit or other payment card, an identity card or the like, having the optically variable security element described. It will be apparent that the value document can be modified in the same ways, as already described, as the optically variable security element. Here it is equally possible to apply the described micromirror arrangement directly to the value document or to the substrate body of the value document.

Likewise provided is a method for producing an optically variable security element in one of the embodiments described above. A substrate body defining a base plane is provided and a micromirror arrangement which is embodied as a two-dimensional array of micromirrors which form pixels of a representation perceptible when the substrate body is viewed in plan view is embodied or arranged on the substrate body. The micromirror arrangement comprises first micromirrors and second micromirrors, with the first micromirrors having planar mirror faces inclined relative to the base plane and at least the second micromirrors each comprising a biaxially curved mirror face. More preferably, the second micromirrors have a plurality of partial mirror faces which are biaxially curved.

It will be appreciated that the method is used to produce the optically variable security element described above and can thus be modified in the same ways, as already described, as the optically variable security element and the value document.

It will be appreciated that the abovementioned features and those still to be elucidated below may be used not only in the specified combinations but also in different combinations or on their own without departing from the scope of the present invention.

### BRIEF DESCRIPTION OF THE DRAWINGS

The invention is elucidated in greater detail hereinafter by working examples with reference to the accompanying drawings, which likewise disclose features essential to the invention. These working examples serve merely for illustration and should not be interpreted in a limiting manner. By way of example, a description of a working example with a multiplicity of elements or components should not be interpreted to the effect that all these elements or components are necessary for implementation. Instead, other working examples may also contain alternative elements and components, fewer elements or components, or additional elements or components. Elements or components of different working examples can be combined with one another, unless stated otherwise. Modifications and alterations described for one of the working examples may also be applicable to other working examples. In order to avoid repetitions, elements that are identical or correspond to one another in different figures are designated by identical reference signs and are not explained repeatedly. In the figures,

FIG. 1 shows a security element with a noisy background effect in the plan view at two different tilt angles,

FIG. 2 shows a security element with a uniform background effect in the plan view at two different tilt angles,

FIG. 3A shows a first detail in the security element according to FIG. 1 in grayscale representation in plan view,

FIG. 3B shows the first detail according to FIG. 3A in plan view in schematic representation,

FIG. 4A shows a second detail in the security element according to FIG. 2 in grayscale representation in plan view,

FIG. 4B shows the second detail according to FIG. 4A in plan view in schematic representation,

FIG. 5A shows a third detail in the security element according to FIG. 2 in grayscale representation in plan view, and

FIG. 5B shows the first detail according to FIG. 5A in plan view in schematic representation,

Structures that correspond to one another structurally or functionally are each given the same reference sign in the figures.

### DETAILED DESCRIPTION OF VARIOUS EMBODIMENTS

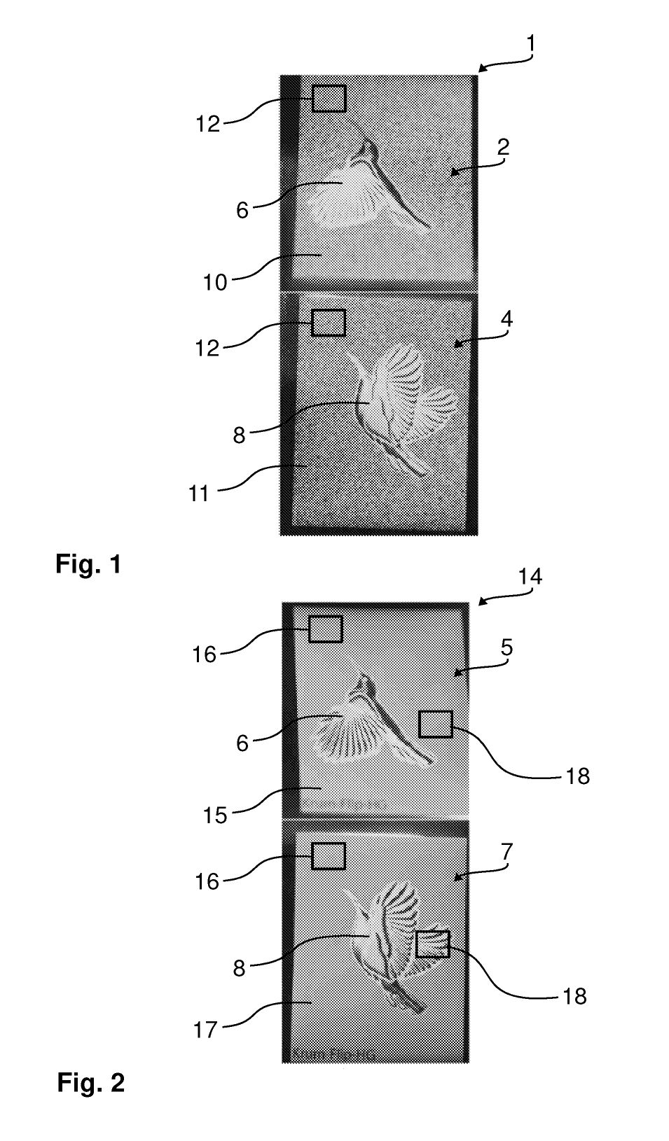

FIG. 1 showsa first security element 1 in the plan view in a first view 2 when viewed perpendicularly at a first tilt angle and in a second view 4 at a second, different tilt angle. A first flip motif 6 and a second flip motif 8 are represented. Likewise represented are a noisy background of the first view 10, a noisy background of the second view 11 and a first detail 12 in the region of the noisy background 10, 11. The first flip motif 6 and the noisy background of the first view 10 together represent the first view of a representation, and the second flip motif 8 and the noisy background of the second view 11 together represent the second view of the representation.

FIG. 2 shows basically the same representation as FIG. 1 for a second security element 14. The second security element 14 is shown in the plan view when viewed perpendicularly in a first view 5 at the first tilt angle and in a second view 7 at the second, different tilt angle. The first flip motif 6 and the second flip motif 8 are likewise perceptible. In contrast to FIG. 1, FIG. 2 provides a smooth background 15 in the first view 5 and a smooth background 17 in the second view 7. In the region of the smooth background 15, 17, a second detail 16 is provided. A third detail 18 is provided likewise in the region of the second flip motif 8 (when viewed at the second tilt angle) or of the smooth background 15 (when viewed at the first tilt angle). The first flip motif 6 and the smooth background 15 together represent the first view 5 of a representation, and the second flip motif 8 and the smooth background 17 together represent the second view 7 of the representation.

The representations shown in FIGS. 1 and 2 are generated by micromirror arrangements 19 which are applied on the front of a substrate body. In this case, it is equally possible that a microfacet arrangement is embossed into a dielectric layer and then provided with a reflective layer to embody the micromirror arrangement 19, or that the micromirror arrangement 19 is formed entirely by a metal layer which is applied on the front of the substrate body.

As the representation in FIGS. 1 and 2, a flip motif 6, 8 is represented in front of a background 10, 11, 15, 17. Instead of the flip motif 6, 8, any other representation is equally possible, all of which can be combined with the second micromirrors 22, 24 according to the invention.

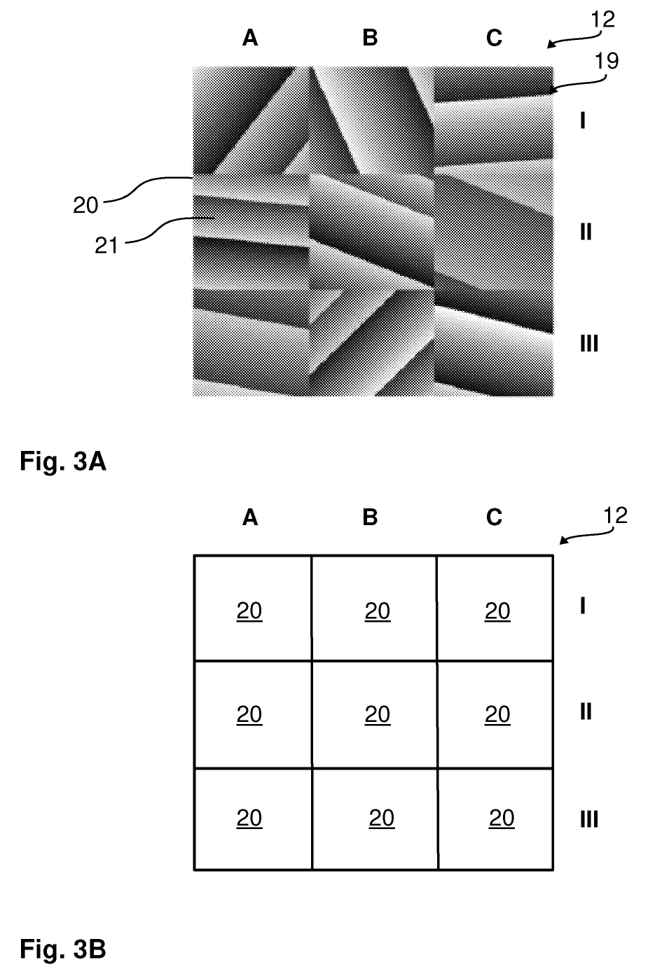

In FIGS. 3A and 3B, the first detail 12 is represented in plan view. FIG. 3A represents a detail view of the micromirror arrangement 19 of the noisy background 10, 11, as it is known from the prior art, as a grayscale image. In the grayscale image of FIG. 3A, the highest regions of the micromirror arrangement 19 are represented in white and the lowest regions of the micromirror arrangement 19 are represented in black. FIG. 3B schematically represents the first detail 12 according to FIG. 3A. A total of 9 square noisy micromirrors 20 are represented in a 3x3 arrangement. The noisy micromirrors 20 are arranged in rows and columns, with the columns denoted A, B and C, and the rows denoted I, II and III. It will be appreciated that the number of noisy micromirrors 20 was chosen only as an example and for illustration purposes. In reality, the micromirror arrangement 19 has a multiplicity of noisy micromirrors 20, which may also, for example, have a rectangular shape.

In the noisy micromirrors 20, a plurality of partial mirror faces 21 are provided, which are randomly oriented, so that the multiplicity of noisy micromirrors 20 jointly embody the noisy background 10, 11. It is evident that the noisy background 10, 11 consists of a multiplicity of planar, inclined partial mirror faces 21. Owing to the random orientation of the partial mirror faces 21, the noisy micromirrors 20 illuminate with different brightnesses, which leads to a fuzzy appearance of the noisy background 10, 11.

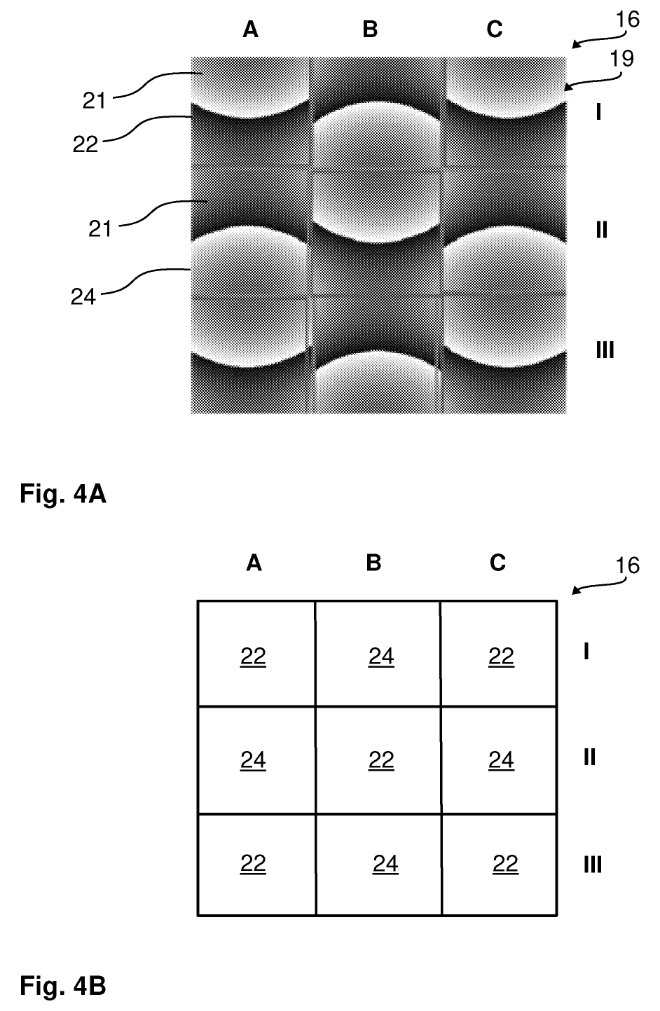

FIGS. 4A and 4B show the second detail 16 in plan view; FIG. 4A represents a detail view of the smooth background 15, 17 according to the invention as a grayscale image. As in FIG. 3A, in the grayscale image of FIG. 4A, the highest regions of the micromirror arrangement 19 are represented in white and the lowest regions of the micromirror arrangement 19 are represented in black. FIG. 4B schematically represents the first detail 12 according to FIG. 4A. The second micromirrors 22, 24 are arranged in rows and columns, with the columns denoted A, B and C, and the rows denoted I, II and III. A total of 9 square second micromirrors of the first type 22 and second type 24 are represented in a 3x3 arrangement. The second micromirrors of the first type 22 are interspersed with the second micromirrors of the second type 24 in the form of a chessboard. The second micromirrors of the first type 22 are arranged in the fields AI, AIII, BII, CI and CIII, and the second micromirrors of the second type 24 are arranged in the fields AII, BI, BIII and CII. It will be appreciated that the number of fields was chosen only as an example and for illustration purposes. In reality, the micromirror arrangement 19 has a multiplicity of second micromirrors 22, 24, which may also, for example, have a rectangular shape. They can also be interspersed with one another in other ways than in chessboard form.

The second micromirrors 22, 24 have pairs of partial mirror faces 21 inclined multiply relative to a base face; the partial mirror faces 21 are biaxially curved and thus have a curvature in two mutually perpendicular directions. Jump discontinuities are provided between the partial mirror faces 21. It will be appreciated that the second micromirrors may also have more than two inclined partial mirror faces 21 with intervening jump discontinuities. In that case, the partial mirror faces 21 embody a Fresnel structure. Equally, it would also be possible for only a single biaxially curved mirror face to be provided, instead of the partial mirror faces. The partial mirror faces 21 are inclined differently in the second micromirrors of the first type 22 and the second micromirrors of the second type 24, and the partial mirror faces 21 cannot be discerned with the naked eye by an external observer.

The represented two-dimensional array of second micromirrors 22, 24 generates a smooth background 15, 17, which has a uniform brightness independently of the tilt angle and thus independently of the view 5, 7 of the representation, and thus has a more attractive appearance than the noisy background 10, 11 in the two views 2, 4. The effect of the uniform brightness is in fact even improved in this embodiment, in that second micromirrors of the first type 22 and second type 24 are arranged interspersed with one another. Accordingly, ghost images of the flip motifs 6, 8 can also be selectively outshone, which further improves the visual attractiveness of the security element 14.

The first flip motif 6 is perceptible in the first view 5 on perpendicular viewing at the first tilt angle, but disappears in the second view 7 on perpendicular viewing at the second tilt angle. The second flip motif 8 is not perceptible in the first view 5 on perpendicular viewing at the first tilt angle, but appears in the second view 7 on perpendicular viewing at the second tilt angle. Both flip motifs 6, 8 are located, as seen spatially, on the same face of the security element 1, 14. They are composed of a multiplicity of first micromirrors 26, of which one part shows the first flip motif 6 and one part shows the second flip motif 8 and which are interspersed with one another in a chessboard manner analogously to the details 12, 16 represented, so that depending on the tilt angle, the first flip motif 6 or the second flip motif 8 appears.

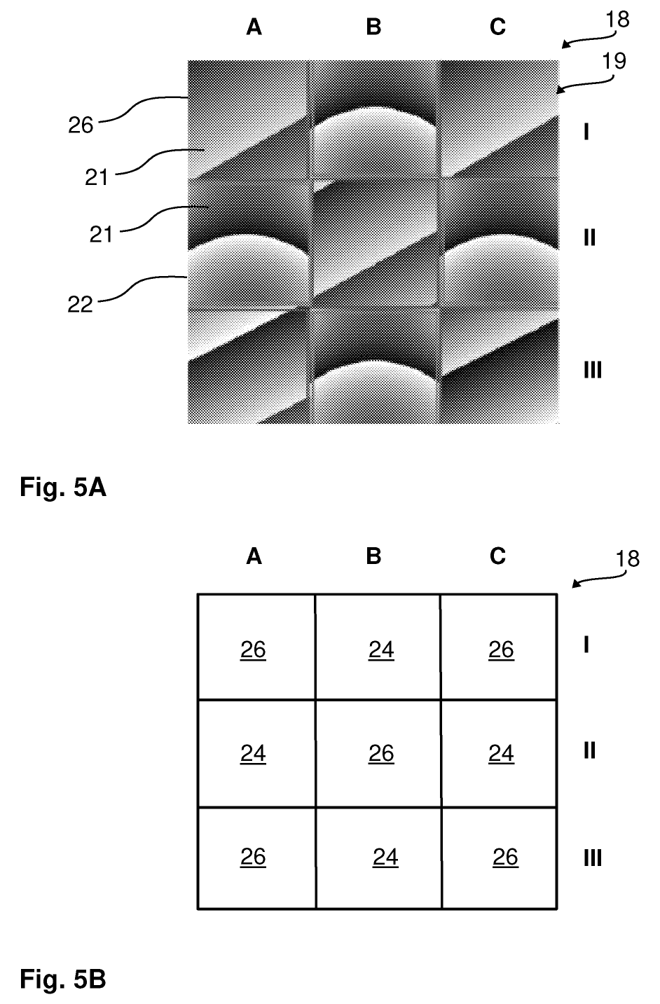

FIGS. 5A and 5B show the third detail 18 in plan view; FIG. 5A represents a detail view as a grayscale image of regions of the security element 14 in which the smooth background 15 according to the invention and the second flip motif 8 are present in areal overlap. As in FIGS. 3A and 4A, in the grayscale image of FIG. 5A, the highest regions of the micromirror arrangement 19 are represented in white and the lowest regions of the micromirror arrangement 19 are represented in black. FIG. 5B schematically represents the first detail 12 according to FIG. 5A. The first micromirrors 26 and the second micromirrors 24 are arranged in rows and columns, with the columns denoted A, B and C, and the rows denoted I, II and III. A total of 9 square first micromirrors 26 and second micromirrors 24 (second type) are represented in a 3x3 arrangement. The second micromirrors 24 are interspersed with the first micromirrors 26 in the form of a chessboard. The first micromirrors 26 are arranged in the fields AI, AIII, BII, CI and CIII, and the second micromirrors 24 are arranged in the fields AII, BI, BIII and CII. It will be appreciated that this number was chosen only as an example and for illustration purposes. In reality, the micromirror arrangement 19 has a multiplicity of first micromirrors 26 and second micromirrors 24, which may also, for example, have a rectangular shape. They can also be interspersed with one another in other ways than in chessboard form. The interspersion of second flip motif 8 and smooth background 15 as represented also ensures a background with uniform brightness, which is visible at the first tilt angle, in the region of the flip. The background 15 ensures that no ghost image of the second motif 8 is visible at the first tilt angle. The same arrangement is present in regions in which the smooth background 17 and the first flip motif 6 are present in areal overlap, with the difference that first micromirrors 26 are provided there which depict the first flip motif 6 (not explicitly represented).

In a further embodiment, it would also be possible for the structure represented in FIG. 3A, in one or both of the views 5, 7, to embody a motif, such as a cloud, in the otherwise smooth background 15, 17. Then, on macroscopic viewing, the observer would discern a background with uniform brightness and, on closer viewing, would perceive a fuzzily represented cloud on an otherwise smooth background 15, 17. This increases the anticounterfeiting security in a surprising way.

### LIST OF REFERENCE SIGNS

1 first security element

2 first view of the first security element

4 second view of the first security element

5 first view of the second security element

6 first motif

7 second view of the second security element

8 second motif

10 noisy background of the first view

11 noisy background of the second view

12 first detail

14 second security element

15 smooth background of the first view

16 second detail

17 smooth background of the second view

18 third detail

19 micromirror arrangement

20 noisy micromirrors

21 partial face

22 second micromirrors of the first type

24 second micromirrors of the second type

26 first micromirrors

What is claimed is:

1. An optically variable security element for securing security papers, value documents, or value articles, which has:
a substrate body defining a base plane, and
a micromirror arrangement which is embodied or arranged on the substrate body and is embodied as a two-dimensional array of micromirrors which form pixels of a representation perceptible when the substrate body is viewed in plan view, with
the micromirror arrangement comprising first micromirrors and second micromirrors, and
the first micromirrors having planar mirror faces inclined relative to the base plane,
wherein the second micromirrors have a biaxially curved mirror face.

2. The security element according to claim 1, wherein at least the second micromirrors each comprise a plurality of partial mirror faces, which are biaxially curved.

3. The security element according to claim 1, wherein the second micromirrors form pixels in a nonstructured region of the representation.

4. The security element according to claim 1, wherein the two-dimensional array of micromirrors displays a first view of the representation at a first viewing angle, and a second view of the representation at a second viewing angle.

5. The security element according to claim 4, wherein a first pixel group displays the first view and a second pixel group displays the second view of the representation.

6. The security element according to claim 5, wherein the micromirrors of the two pixel groups are interspersed with one another at least in one region of the micromirror arrangement.

7. The security element according to claim 6, wherein, in at least one region of the micromirror arrangement, first micromirrors of the first pixel group and second micromirrors of the second pixel group are arranged repeatedly next to one another.

8. The security element according to claim 6, wherein, in at least one region of the micromirror arrangement, second micromirrors of a first type of the first pixel group and second micromirrors of a second type of the second pixel group are arranged repeatedly next to one another, with the two types of second micromirrors differing in a curvature of their mirror faces.

9. The security element according to claim 1, wherein the mirror face of the second micromirrors has a continuously curved or a parabolically curved surface shape.

10. The security element according to claim 1, wherein the surface shape of the mirror face of the second micromirrors has at least one elevation and/or at least one depression.

11. The security element according to claim 1, wherein the micromirror arrangement has a reflective layer, more particularly a multilayer coating.

12. The security element according to claim 1, wherein a tangent of the curvature of the surface of the mirror faces of the second micromirrors is located in the range of +/- 45° to the base plane.

13. The security element according to claim 1, wherein the mirror faces of the second micromirrors, as seen perpendicular to the base plane, have a maximum height extent of 0.5 µm to 10 µm.

14. A value document, such as a banknote, a check, a credit card or other payment card, an identity card or the like, having an optically variable security element according to claim 1.

15. A method for producing an optically variable security element according to claim 1, in which
a substrate body defining a base plane is provided, and
a micromirror arrangement which is embodied as a two-dimensional array of micromirrors which form pixels of a representation perceptible when the substrate body is viewed in plan view is embodied or arranged on the substrate body,
where the micromirror arrangement comprises first micromirrors and second micromirrors, with the first micromirrors having planar mirror faces inclined relative to the base plane,
wherein the second micromirrors have a biaxially curved mirror face.
